(19) United States
(12) Patent Application Publication
(10) Pub. No.: US 2006/0171770 A1
(43) Pub. Date: Aug. 3, 2006

(54) Illuminated lip treatment device

(76) Inventor: Mary Kay Bitton, Westlake Village, CA (US)

Correspondence Address: CROCKETT & CROCKETT, 24012 CALLE DE LA PLATA, SUITE 400, LAGUNA HILLS, CA, 92653, US

(21) Appl. No.: 11/345,078

(22) Filed: Jan. 31, 2006

Related U.S. Application Data
(60) Provisional application No. 60/648,941, filed on Jan. 31, 2005.

(51) Int. Cl. B43K 29/00

(52) U.S. Cl. 401/195

(57) ABSTRACT

An illuminated lip treatment device according to the present disclosure provides a source of illumination incorporated in the applicator, the cap, or the product container. The illumination may be energized using any suitable technique such as a button or switch or by loosening the cap. An illuminated lip treatment device may also incorporate designs or text in the applicator, cap, or container that may be emphasized by energizing the incorporated illumination. The incorporated illumination may be provided by one or more illumination elements such as bulbs or LEDs or other suitable devices. An illuminated lip treatment device according to the present disclosure may also provide a light source for locating items in the dark or within closed containers such as purses or backpacks.

This application claims priority to Provisional Patent Application 60/648,941, filed Jan. 31, 2005.

### FIELD OF THE INVENTION

The present invention relates generally to the field of personal care and more specifically to illuminated lip treatment dispensers.

### DESCRIPTION OF THE PRIOR ART

Conventional lip treatment and coloring dispensers are products of a mature industry.

What is needed is a multifunction lip product or cosmetic dispenser including a light source.

### SUMMARY OF THE INVENTION

In a first aspect of the present disclosure an illuminated lip treatment device provides a source of illumination incorporated in the applicator element. The incorporated illumination may be provided by one or more illumination elements such as bulbs or LEDs or other suitable devices. The illumination may be energized using any suitable technique such as a button, switch or by twisting or otherwise loosening the cap.

In another aspect of the present disclosure an illuminated lip treatment device may include one or more illuminating elements into the applicator cap. In still another aspect of the present disclosure an illuminated lip treatment device may include one or more illuminating elements into the container.

In another aspect of the present disclosure an illuminated applicator element, cap, or container may incorporate designs or text that are emphasized by energizing the incorporated illumination.

An illuminated lip treatment device according to the present disclosure may provide a light source for locating items in the dark or within closed containers such as purses or backpacks. The device may also provide illumination to the user while the lip treatment is being applied.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1 is a perspective view of an illuminated lip treatment device according to the present disclosure.

FIG. 2 is a perspective view of an illuminated lip treatment device according to an alternate embodiment of the present disclosure.

FIG. 3 is a side view of an illuminated lip treatment device according to the present disclosure.

FIG. 4 is a top view of the illuminated lip treatment device of FIG. 3.

FIG. 5 is a cutaway view of the illuminated lip treatment device of FIG. 3.

FIG. 6 is a side view of an illuminated lip treatment device according to the present disclosure.

FIG. 7 is a side view of an illuminated lip treatment device according to the present disclosure.

FIG. 8 is a cutaway view of an illuminated lip treatment device according to the present disclosure.

### DETAILED DESCRIPTION

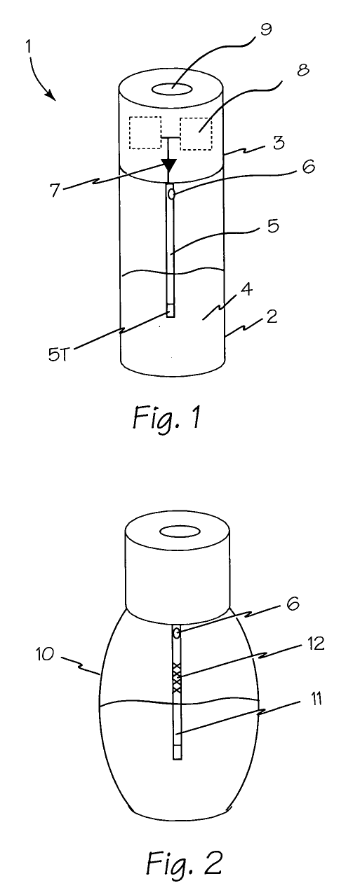

Referring now to FIG. 1, illuminated lip treatment device 1 includes product container 2 and cap 3. Cap 3 engages container 2 in any suitable manner to retain product 4 within container 2. Dispensing of product 4 may be accomplished using applicator 5 attached to cap 3. Applicator tip 5T may have any suitable configuration such as brush or sponge. Applicator 5 may also include one or more illumination elements 6. Illumination may be provided by one or more illumination elements such as bulbs or LEDs or other suitable devices. Illumination element 6 may receive energy 7 from one or more energy elements 8, such as a battery or other. Energy 7 may be controlled using any suitable means, such as switch 9 activated, twist activated, motion activated, or by disengaging cap 3 from container 2.

In use, the operator may push the switch 9 or otherwise activate the illumination element and the illuminated lip treatment device will remain on until the user turns it off. Alternatively, the operator may push the switch 9 or otherwise activate the illumination element and the illuminated lip treatment device will remain on only as long as the switch is depressed. A timer may incorporated to shut the device off after a specified period of time. The resulting illumination may be continuous, blinking, strobing, or other.

Alternatively, container 10 may have any suitable shape, as shown in FIG. 2. Applicator 11 may include text or graphics 12 stamped, molded, printed or otherwise applied to applicator 11. Illumination of applicator 11 may emphasize text or graphics 12.

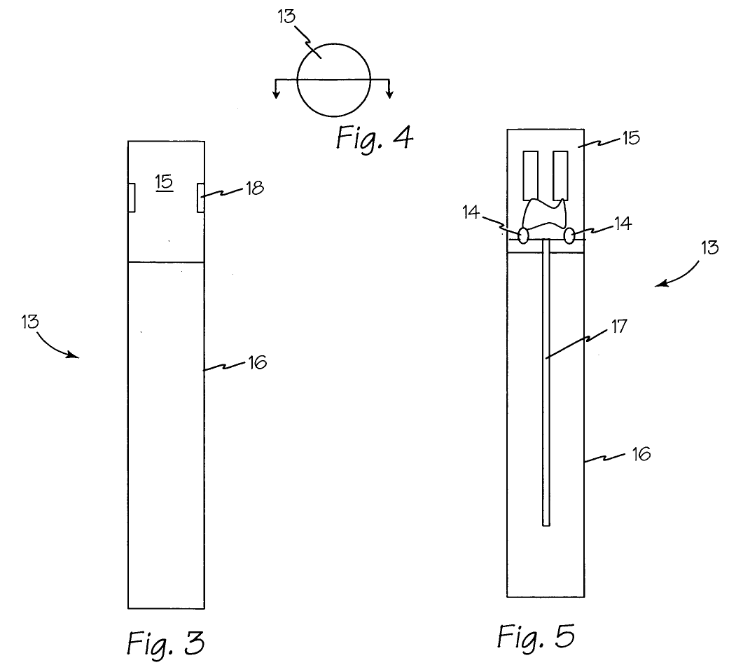

Illuminated lip treatment dispenser 13 may incorporate one or more illuminating elements 14 in cap 15, as shown in FIG. 3, FIG. 4, and FIG. 5. Disengaging cap 15 from product container 16 permits illuminating elements 14 to illuminate applicator 17. When applicator 17 is in use, illuminating elements 14 may provide illumination on an area for application of the product on or in applicator 17. Cap 15 may include one or more buttons or contacts 18 for energizing illumination elements 14, as shown in FIG. 3.

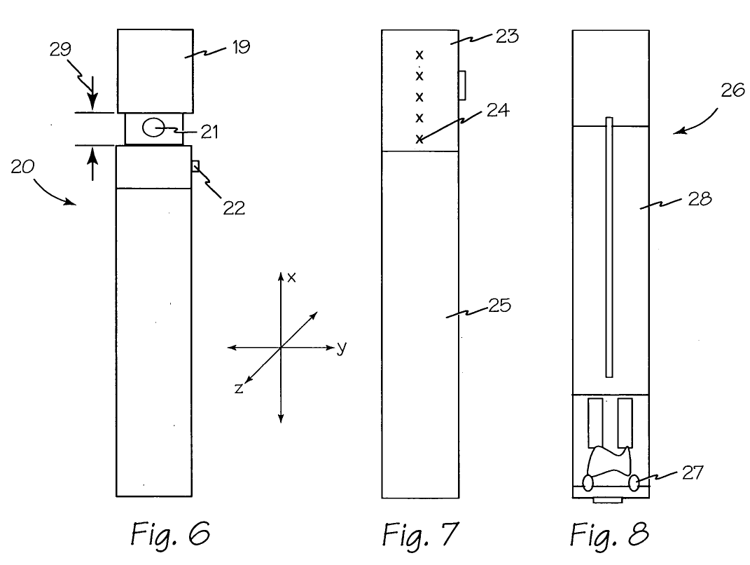

Cap 19 may have any suitable shape, as shown in FIG. 6. Dispenser 20 may include an offset 29 when cap 19 is fully engaged to dispenser 20. Illumination element 21 may be exposed through offset 29. Switching means 22 may also be located on the cap.

Cap 23 may include text or graphics 24 stamped, molded, printed or otherwise applied to the cap 23, as shown in FIG. 7. Illumination of cap 23 may emphasize text or graphics 24. Illumination may also be directed up along the x axis and down towards the container 25, or out perpendicular to the outer surface of the cap in the y-z plane, or any combination.

Illuminated lip treatment device 26 may incorporate one or more illuminating elements 27 in the container 28, as shown in FIG. 8. Container 28 may include text or graphics stamped, molded, printed or otherwise applied to container 28.

The lip treatment device may incorporate more than one illuminating elements in the applicator, the container, as well as in the cap, directing illumination in the applicator, the container, and the cap. The means for illuminating the lip treatment device may be placed on the container, the cap, or otherwise accessible to the user.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

I claim:

1. An illuminated lip treatment device comprising:
a container with a releasable cap;
a product applicator connected to the cap;
a means for illuminating the lip treatment device attached to the product applicator; and
a switch operably connected to the lip treatment device and accessible to the user; said switch controlling the illuminating means.

2. An illuminated lip treatment device comprising:
a container with a releasable cap;
a product applicator connected to the cap;
a means for illuminating the lip treatment device attached to the cap; and
a switch operably connected to the lip treatment device and accessible to the user; said switch controlling the illuminating means.

3. An illuminated lip treatment device comprising:
a container with a releasable cap;
a product applicator connected to the cap;
a means for illuminating the lip treatment device attached to the container; and
a switch operably connected to the lip treatment device and accessible to the user; said switch controlling the illuminating means.
